(19) United States
(12) Patent Application Publication
(10) Pub. No.: US 2023/0294545 A1
(43) Pub. Date: Sep. 21, 2023

(54) Method for Supplying Electrical Energy, Supply Device, Computer Program Product and Computer-Readable Storage Medium

(71) Applicant: Bayerische Motoren Werke Aktiengesellschaft, Muenchen (DE)

(72) Inventors: Joachim KOLLING, Eching (DE); Thomas SCHMID, Groebenzell (DE)

(21) Appl. No.: 18/017,556

(22) PCT Filed: Jul. 7, 2021
(86) PCT No.: PCT/EP2021/068733

§ 371 Date: Jan. 23, 2023

(30) Foreign Application Priority Data
Aug. 4, 2020 (DE) 10 2020 120 577.5

(51) Int. Cl. B60L 53/68; G06Q 50/06

(52) U.S. Cl. CPC B60L 53/68; G06Q 50/06

(57) ABSTRACT

The invention relates to a method for supplying electric energy for an electrically operatable motor vehicle, wherein electric energy is received from a power grid by means of a supply device (12); respective generation information is received for each energy packet received from the power grid, said information being assigned to the respective energy packet via distributed ledger technology and characterizing a generation property assigned to the received energy packet; electric energy from at least one energy packet is supplied to the motor vehicle; and supply information (10) is supplied to the motor vehicle, said information characterizing the respective assigned generation property of the at least one energy packet of the electric energy supplied to the motor vehicle.

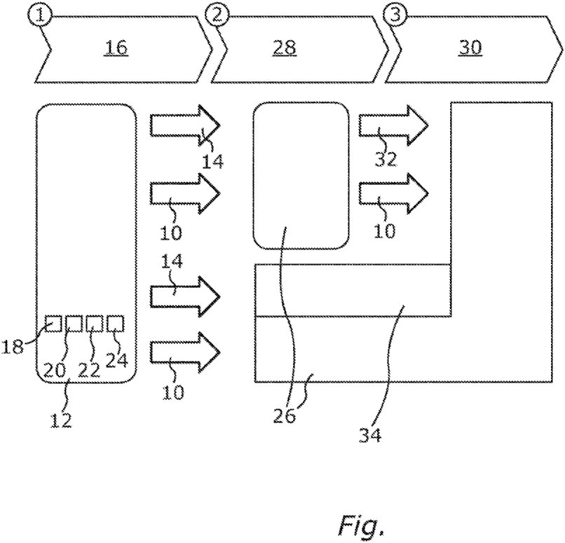

### BACKGROUND AND SUMMARY OF THE INVENTION

The technology disclosed herein relates to a method for supplying electrical energy for an electrically-powered motor vehicle, to a supply device for supplying electrical energy for an electrically-powered motor vehicle, to a computer program product and to a computer-readable storage medium.

Published documents WO 2017/199053 A1, EP 2604468 A1and CN 109034840 A are included in the prior art.

A particular object of the technology disclosed herein is the provision of a method for supplying electrical energy for an electrically-powered motor vehicle, a supply device for supplying electrical energy for an electrically-powered motor vehicle, a computer program product and a computer-readable storage medium which provide a customer with particularly effectively reproducible, particularly tamper-proof and thus verifiable evidence of the charging of the motor vehicle with a sustainable charging current. Further preferred functions can proceed from the advantageous effects of the technology disclosed herein.

The object thus described is fulfilled by the subject matter of the claimed invention.

The technology disclosed herein relates to a method for supplying electrical energy for an electrically-powered motor vehicle, wherein electrical energy is received from a power grid by way of a supply device. The supply device comprises, for example, a charging cable, a “wallbox” or a charging column.

According to the method, it is further provided that, by way of the supply device, respective generation information is received for each energy packet received from the power grid, which information being assigned to the respective energy packet via a distributed ledger technology and characterizing a generation property which is assigned to the energy packet received. By way of the distributed ledger technology, transactions can be documented in a particularly tamper-proof manner. An arbitrary number of, in principle, identical copies of a ledger can thus be maintained in a decentralized manner by different parties. This ledger is a type of journal. Newly-entered transactions are incorporated in all copies of the ledger, such that consistency with respect to transactions executed is present in all ledgers.

According to the method, it is further provided that, by way of the supply device, electrical energy from at least one energy packet is supplied to the motor vehicle and, by way of the supply device, supply information for the motor vehicle is delivered which characterizes the respectively assigned generation property of the at least one energy packet of electrical energy supplied for the motor vehicle.

In particular, the supply device can form part of a charging station, a charging cable and/or a wallbox, which is designed to charge the electrically-powered motor vehicle with electrical energy.

In other words, generation information is assigned to respective energy packets in the power grid by way of the distributed ledger technology, which information is receivable by the supply device of the at least one energy packet of the respective energy packets thus assigned. Assignment of the at least one element of generation information to the respective energy packet by way of the distributed ledger technology permits a particularly effective tamper protection of generation information, and thus of the assignment of generation information to the respective energy packet. By way of the supply device, both energy packets and the generation information assigned to energy packets are thus received, as a result of which, by way of the supply device, energy packets can be offered to respective motor vehicles in a targeted manner which, by way of the generation information assigned by the distributed ledger technology, have demonstrably been produced from renewable energy sources, for example from photovoltaic energy and/or wind power. Generation information assigned to the respective energy packets provides particularly secure, and thus verifiable evidence to the effect that energy packets supplied or consumed possess a specific generation property which is represented by the generation information.

By way of the supply device, supply information is constituted from the respective generation information for energy packets supplied to the motor vehicle, and is available for the motor vehicle. By way of the supply information, a vehicle proprietor, owner, keeper or user - for example a private owner (B2C), fleet customer and/or fleet manager (B2B) - can confirm the generation property of electrical energy supplied for the motor vehicle by the supply device, particularly in the form of energy packets. By way of the method thus described, it is demonstrable, in a particularly tamper-proof manner, that electrical energy supplied for the motor vehicle in the form of at least one energy packet has been supplied in accordance with the generation information.

In particular, the method can be applied equally for either AC current or DC current, and/or independently of the charging capacity of the supply device or the electric vehicle. The method is, moreover, independent of whether electricity generation and/or the charging process is conducted in private, specifically at home, in a workplace or a business, or in a public space, particularly on the roadside, in a parking garage, on a motorway and/or at a charging hub. The method describes a network, the generation and charging points of which are movable, and thus geographically independent. This applies to the electric vehicle carrying a battery (automobile), and to movable charging stations or charging units, and to the charging cable.

In a further development, it has proved to be particularly advantageous if supply information is assigned to the motor vehicle, and is made available to a superordinate computing device. The superordinate computing device, in particular, is a server facility and/or cloud solution. In this superordinate computing device, in particular, a plurality of supply information from a plurality of motor vehicles can be consolidated and evaluated in combination. For a number of motor vehicles in a fleet, for example, it can thus be determined which form of energy accounts for which proportion of energy consumption of the fleet. Accordingly, energy consumption of the fleet can be analyzed and evaluated in a particularly comprehensive and tamper-proof manner. This is particularly advantageous for the purposes of testing and/or certification, particularly with respect to the CO₂ emissions of B2B fleets or of the entire vehicle fleet of a manufacturer or an original equipment manufacturer (OEM).

In a further configuration of the method, it has proved to be advantageous if the respective generation property is assigned to the respective energy packet by way of at least one blockchain, or by way of distributed ledger technology in the form of Ethereum or Hyperledger. A “blockchain” is a continuously expandable series of data records, described as “blocks”. These blocks are interlinked by cryptographic methods, wherein each block typically comprises a cryptographically secure hash code, representing an erratic value, for a preceding block, a time stamp and transaction data. Ethereum is an open source distributed system, which delivers functions for the input, administration and execution of decentralized programs or smart contracts in a dedicated blockchain. Hyperledger is an open source system, in which a series of stable frameworks, tools and libraries for blockchain implementation functions are provided by an open source community. These distributed ledger technologies are particularly tamper-proof, and thus provide particularly tamper-proof evidence of the assignment of respective generation information to the associated energy packet.

It has further proved to be advantageous if the generation information is characteristic of an energy source of electrical energy and/or of a generation time point of the electrical energy of the respective energy packet. In particular, for the generation of the electrical energy of the respective energy packet, the respective generation time point and/or the respective nature of the energy source can be determined, and the quantity of energy thus delivered assigned to the respective energy packet. As a result, by way of generation information, it can be established at which generation time point which quantities of electrical energy in the form of a respective energy packet have been delivered by a respective energy source. Generation information for an energy source can thus be characteristic, both of the nature of the respective energy source and of a respective individual electricity generating unit, for example a power plant unit, for example a specific electricity generating device, such as a generator, in the power plant unit. In particular, the energy source from which electricity generated, for example photovoltaic energy, wind and/or water power, is preferred by customers can thus be tracked, and sales thereof promoted in a particularly effective manner. In particular, respective electricity generating capacity which employs this energy source can be expanded as a result. It is, moreover, possible to employ locally or regionally generated green electricity, and for this to be confirmed in a verifiable manner.

The technology disclosed herein further relates to a supply device for supplying electrical energy to an electrically-powered motor vehicle. The supply device comprises a first terminal device, by way of which electrical energy can be sourced from a power grid. The supply device further comprises an electronic receiver device, by way of which, for respective energy packets of electrical energy received from the power grid, generation information which is assigned to the respective energy packet by way of a distributed ledger technology is receivable in each case, which is characteristic of the generation property assigned to the energy packet received. The supply device moreover comprises a second terminal device, by way of which electrical energy from at least one energy packet is available for delivery to the motor vehicle. The supply device further comprises an electronic transmitter device, by way of which supply information for the motor vehicle can be delivered. Alternatively or additionally to the electronic transmitter device, the supply device can comprise an electronic interface, particularly in accordance with ISO 15118. Supply information is characteristic of the respectively assigned generation property of the at least one energy packet of electrical energy supplied for the motor vehicle.

The supply device, in particular, can be part of a charging station, for example a charging column, for the motor vehicle. In particular, the motor vehicle, particularly the electrically-powered motor vehicle, is connectable to the supply device, as a result of which electrical energy can be transmitted from the supply device to the motor vehicle, and supply information can be transmitted from the supply device to the motor vehicle.

The supply device is particularly designed to execute the method described above in conjunction with the method for supplying electrical energy for the electrically-powered motor vehicle. The supply device is further designed to process respective generation information for energy packets received from the power grid, and to produce supply information from the generation information thus processed. This supply information, which is derived from the generation information, can be delivered by the supply device for the motor vehicle, as a result of which the motor vehicle can be notified of respective energy sources and/or generation time points of electrical energy in the respective energy packets, from which energy has been supplied to the motor vehicle. By way of the supply device, a proprietor or owner and/or a keeper of the motor vehicle can thus be notified, in a particularly convenient and tamper-free manner, of a respective generation property of the electrical energy supplied to the motor vehicle.

The technology disclosed herein further comprises a computer program product, comprising commands which initiate the execution by the supply device of process steps in accordance with the above-mentioned method for supplying electrical energy for an electrically-powered motor vehicle. The computer program product can be designed for the aggregation and/or reporting of charging processes. The technology disclosed herein further comprises a computer-readable storage medium, on which program instructions are saved which, upon the execution thereof by a microprocessor, cause the latter to execute the above-mentioned method for supplying electrical energy for an electrically-powered motor vehicle. This computer-readable storage medium can be assigned to a backend and/or a cloud solution.

In other words, the technology disclosed herein involves both ex-ante and ex-post green classification. In the case of ex-ante green classification, the respective unit of electrical energy generated, for example a megawatt-hour, by the application of distributed ledger technology, for example upon the injection thereof, in addition to the metrological recording of additional data, specifically generation information, assumes the property of green electricity. These data, particularly generation information, by the application of distribution ledger technology, cannot be manipulated, or are extremely difficult to manipulate, and can thus be transmitted over an entire process chain, encompassing generation, the grid, the charging column, an e-roaming provider, an e-mobility service provider (or eMSP) and the consumer, in a particularly tamper-proof or verifiable manner. In the case of ex-post green classification, the consumer, particularly a private individual or a business, can classify a charging process of the motor vehicle as green, for example as a way of offsetting their carbon footprint. This can be executed in an analogous manner to an airline ticket, wherein a carbon footprint can be offset in return for the payment of a surcharge.

The method thus described also permits the provision of value-added services, particularly by an operator of the supply device. By way of a value-added service, particularly tamper-proof data which are characteristic of generation information, on the basis of distributed ledger technology, can be aggregated and processed to form target group-specific combinations of information, such as a verifiable report. Charging column operators, and thus operators of the supply device, can sell green electricity as a value-added service. A service of an e-roaming provider specifically comprises the provision of a data platform based upon a distributed ledger technology, together with associated data aggregation. A value-added service of the e-mobility service provider can comprise, for example, the preparation of reports for businesses, by way of evidence for the latter in support of sustainability reports, vehicle taxation, etc.. Accordingly, not only one verification or application of distributed ledger technologies can be employed in the generation of green electricity, but rather the method can involve the combination of tamper-proof data by the application of a distributed ledger technology, data aggregation can be executed, and IT processing can be undertaken for final customers such as private consumers, fleets or original equipment manufacturers (OEMs), together with value-added services based thereupon. The method further permits the provision of evidence of CO₂ neutrality over an entire process chain, specifically with respect to well-to-wheel, in fulfilment of regulatory requirements.

The technology disclosed herein will now be described in an exemplary manner with reference to the figure.

### BRIEF DESCRIPTION OF THE DRAWING

The FIGURE shows a process diagram of a method for supplying electrical energy for an electrically-powered motor vehicle, wherein particularly tamper-proof data on green electricity status are received, aggregated and processed in a target group-specific manner to constitute verifiable evidence, and processed for the attention of a stakeholder such as an original equipment manufacturer, a procurement manager or a fleet customer.

### DETAILED DESCRIPTION OF THE DRAWING

In the process diagram in the single figure, a method is represented for the processing of data which are characteristic of electrical energy supplied for a motor vehicle, for the attention of a target group. This electrical energy can be supplied to the motor vehicle, particularly a motor car, and particularly a passenger motor car or a heavy goods vehicle, by way of a supply device 12 which, in the present case, is a charging column.

According to the method, in a first process step 1, supply information 10 is supplied by a charging column operator 16 of the supply device 12, which is characteristic of a respective generation property of the respective electrical energy supplied for the motor vehicle. In addition to the at least one element of supply information 10, the supply device 12 can supply characteristic charging data 14 for a charging process, which can also be described as charging data records and/or charging detail records. This supply device 12 which, in the present case, is configured in the form of a charging column, can be operated by the charging column operator 16. The supply device 12 can deliver alternating current and/or direct current and/or can be designed for high-power charging.

In particular, the method can be applied equally for either AC current or DC current, and/or independently of the charging capacity of the supply device or the electric vehicle. The method is, moreover, independent of whether electricity generation and/or the charging process is conducted in private, specifically at home, in a workplace or a business, or in a public space, particularly on the roadside, in a parking garage, on a motorway and/or at a charging hub. The method describes a network, the generation and charging points of which are movable, and thus geographically independent. This applies to the electric vehicle carrying a battery (automobile), and to movable charging stations or charging units, and to the charging cable.

The supply device 12 is designed to supply electrical energy for the electrically-powered motor vehicle, whereby an energy storage device of the motor vehicle is chargeable with electrical energy. To this end, by way of the supply device 12, particularly by way of a first terminal device 18 of the supply device 12, electrical energy is sourced from a power grid. The supply device 12 further comprises an electronic receiver device 20, by way of which, for respective energy packets of electrical energy received from the power grid, generation information which is assigned to the respective energy packet by way of a distributed ledger technology is receivable. This generation information is characteristic of a generation property which is assigned to the energy packet received. Generation information can be characteristic of an energy source of electrical energy and/or of a generation time point of electrical energy in the respective energy packet. In particular, generation information is characteristic of the nature of the energy source, particularly with respect to either conventional energy sources or renewable energy sources, and also permits the tracking of the quantity of energy generated in the respective energy packet to a power plant, and particularly to a specific electricity generating unit of the power plant.

The supply device 12 further comprises a second terminal device 22, by way of which electrical energy from at least one energy packet can be supplied for the vehicle which is to be charged with electrical energy. During the transmission of electrical energy from the at least one energy packet for the motor vehicle, charging data 14 can be determined. The supply device 12 further comprises an electronic transmitter device 24 and/or an alternative interface, particularly in accordance with ISO 15118, by way of which supply information 10 for the motor vehicle can be delivered which is characteristic of the respectively assigned generation property of the at least one energy packet of electrical energy which is supplied for the motor vehicle.

According to the method, it is thus provided that, by way of the first terminal device 18, electrical energy is sourced from the power grid and that, by way of the electronic receiver device 20, for each of the energy packets received from the power grid respectively, at least one element of generation information which is assigned to the respective energy packet by way of distributed ledger technology is received. The “distributed ledger technology” is particularly a blockchain technology, particularly Ethereum or Hyperledger.

According to the method, it is further provided that, by way of the second terminal device 22 of the supply device 12, electrical energy from the at least one energy packet is supplied for the motor vehicle and, by way of the electronic transmitter device 24 and/or the interface, particularly with the charging device, supply information 10 is delivered for the motor vehicle. In particular, supply information 10 can be delivered to a superordinate computing device 26. This superordinate computing device 26 which, in particular, is a server facility and/or a cloud solution, can be assigned to an e-roaming provider 28, which functions as a data aggregator, or to an e-mobility service provider 30.

In a second process step 2, the at least one element of supply information 10 for the charging data 14 is thus received by the e-roaming provider 28. The e-roaming provider 28 executes a data aggregation of the charging data 14 and/or of supply information 10 which is assigned to the respective charging data 14, to form aggregated charging information data 32. These aggregated charging information data 32, in particular, can be characteristic of respective charging data 14 for respective charging processes of a number of motor vehicles, or of a number of charging processes of one motor vehicle. Supply information 10 assigned to the aggregated charging information data 32, in combination with charging information data 32 from the e-roaming provider 28, can be delivered to the e-mobility service provider. Alternatively, the e-mobility service provider 30 can receive charging data 14, and supply information 10 which is respectively assigned to the charging data 14, directly from the charging column operator 16. By the expansion 34 of a direct connection on the charging column, a proportion of directly transmitted charging data 14, and of the supply information 10 assigned thereto, from the charging column operator 16 to the e-mobility service provider 30 can be expanded, in comparison with transmission via the e-roaming provider. The e-mobility service provider 30 can process aggregated charging information data 32, together with the associated supply information 10, or charging data 14 which is received directly from the charging column operator 16, together with the associated supply information 10, particularly for a vehicle customer or fleet operator. This processing is executed in a third process step 3.

The supply device 12 particularly comprises a computer-readable storage medium on which program instructions are saved which, upon the execution thereof by a microprocessor, cause the latter to execute the above-method for supplying electrical energy for an electrically-powered vehicle. In particular, the supply device 12 can comprise a computer program product, comprising commands which initiate the execution by the supply device 12 of process steps of the above-mentioned method for supplying electrical energy for an electrically-powered motor vehicle.

The method described permits an ex-post green classification of a charging process of the motor vehicle. Additionally, chargeable value-added services or premium services can be provided.

Additionally to charging data 14, data on power quality which, by way of a binary attribute, can also be described as green electricity, particularly the at least one element of supply information 10, can be transmitted, particularly from a charging column operator 16 via the e-roaming provider 28 to the e-mobility service provider 30, or directly from the charging column operator 16 to the e-mobility service provider 30, wherein the charging column operator 16 provides a dedicated charging card, or permits ad hoc charging. In data aggregation, attributes for business-to-business customers such as original equipment manufacturers or fleet operators can be incorporated, and an IT-based processing of data, particularly of charging data 14 and of the respectively assigned supply information 10, can be executed, particularly in the form of a verifiable report, by way of evidence of the CO₂-neutrality of charging current. A combination is thus executed of tamper-proof data, by way of distributed ledger technology, data aggregation and IT processing for final customers, particularly for operators and original equipment manufacturers or long-term private customers.

It is provided that, on the basis of distributed ledger technologies such as blockchain, Ethereum or Hyperledger, each megawatt-hour of electricity generated receives a time stamp, particularly a data element and, in particular, a time which is assigned thereto, from which the energy source from which electricity has been generated can be confirmed in a clear and tamper-proof manner. In particular, it can be confirmed if electricity has been generated from a renewable energy source, such as photovoltaic energy or wind power. This is characterized by the generation information. This generation information, which is characteristic of the energy source and/or of the generation time point of electrical energy in the respective energy packet, and specifically of each individual megawatt-hour of electricity, is particularly tamper-proof, in an analogous manner to charging processes of electric vehicles which are executed with clear evidence to the effect that the charging current originates from renewable energy, and is thus CO₂-free. From a customer perspective, a sustainable charging current is valuable, and may generate a readiness for the payment of a surcharge or provide a basis for premium charging services. Correspondingly, this CO₂-free charging current, in the consideration of an overall process chain of electrical mobility, particularly in the conduct of life-cycle assessments, can be recognized and proved. This can provide an essential basis for the cost-effective fulfilment of any future regulatory requirements with respect to evidence of CO₂, or evidence of sustainability.

The technology disclosed herein thus demonstrates how a distributed ledger technology can be employed in the interests of a sustainable charging current.

The term “essentially” (e.g. “in an essentially perpendicular axis”), in the context of the technology disclosed herein, respectively includes the exact property or value (e.g. “perpendicular axis”), together with any deviations which are immaterial to the function of the property or value (e.g. “a tolerable deviation from the perpendicular axis”).

The above description of the present invention is provided for illustrative purposes only, and is not intended to limit the invention. In the context of the invention, various amendments and modifications are possible, without departing from the scope of the invention and any equivalents thereof.

1-7. (canceled)

8. A method for supplying electrical energy for an electrically-powered motor vehicle, the method comprising, by way of a supply device:
receiving electrical energy from a power grid,
receiving respective generation information for each respective energy packet of electrical energy received, the respective generation information being assigned to the respective energy packet via a respective distributed ledger technology and characterizing a respective generation property which is assigned to the respective energy packet,
supplying electrical energy from at least one of the energy packets for the motor vehicle, and
delivering supply information for the motor vehicle which characterizes the respective generation property assigned to the at least one of the energy packets of the electrical energy supplied for the motor vehicle.

9. The method according to claim 8, wherein supply information assigned to the motor vehicle is delivered to a superordinate computing device.

10. The method according to claim 8, wherein the respective generation property is assigned to the respective energy packet by way of a blockchain by way of distributed ledger technology.

11. The method according to claim 8, wherein the respective generation information is characteristic of at least one of an energy source of electrical energy or a generation time point of the electrical energy of the respective energy packet.

12. A supply device for supplying electrical energy for an electrically-powered motor vehicle, the supply device comprising:
a first terminal device, by way of which electrical energy is sourceable from a power grid,
an electronic receiver device, by way of which, for respective energy packets of electrical energy received from the power grid, respective generation information which is assigned to the respective energy packet by way of a distributed ledger technology is receivable, wherein the respective generation information is characteristic of a respective generation property assigned to the respective energy packet,
a second terminal device, by way of which electrical energy from at least one of the energy packets is available for delivery to the motor vehicle, and
at least one of an electronic transmitter device or an interface, by way of which supply information for the motor vehicle is deliverable, wherein the supply information is characteristic of the respective generation property assigned to the at least one of the energy packets of electrical energy supplied for the motor vehicle.

13. A computer product comprising a non-transitory computer-readable storage medium having stored thereon program code which, when executed on a microprocessor, carries out the method according to claim 8.
